(19) United States
(12) Patent Application Publication
(10) Pub. No.: US 2013/0188838 A1
(43) Pub. Date: Jul. 25, 2013

(54) ATTENTION DETECTION METHOD BASED ON DRIVER'S REFLEX ACTIONS

(71) Applicants: Chia-Chun Tsou, New Taipei City (TW); Chih-Heng Fang, New Taipei City (TW); Po-Tsung Lin, New Taipei City (TW)

(72) Inventors: Chia-Chun Tsou, New Taipei City (TW); Chih-Heng Fang, New Taipei City (TW); Po-Tsung Lin, New Taipei City (TW)

(73) Assignee: UTECHZONE CO., LTD., New Taipei City (TW)

(21) Appl. No.: 13/593,307

(22) Filed: Aug. 23, 2012

(30) Foreign Application Priority Data
Jan. 19, 2012 (TW) 101102169

(51) Int. Cl. G06K 9/00

(52) U.S. Cl. 382/104

(57) ABSTRACT

An attention detection method based on a driver's reflex actions is provided to monitor a driver's instantaneous reflex actions and thereby determine the driver's degree of attention. Basically, the attention detection apparatus provides a stimulus to the driver and then determines how the driver responds to the stimulus. The attention detection apparatus includes an image capturing unit for capturing an image of the driver, a processing unit for performing digital image processing on the image, a safety testing unit for issuing a safety test instruction, and a safety determination unit for performing value comparison and determination according to the characteristics of the image. If the image fails to meet the requirement of the safety test instruction, an alarm signal will be sent out to alert the driver.

### BACKGROUND OF THE INVENTION

1. Technical Field

The present invention relates to a detection method. More particularly, the present invention relates to an attention detection method based on a driver's reflex actions.

2. Description of Related Art

Recently, more and more attention has been placed on driving safety. As is well known, many traffic accidents are associated with drivers' incorrect operations which are typically caused by fatigue due to insufficient sleep, driving for long hours without taking a rest, or driving under the influence. Once a driver is absentminded, distracted, or in poor mental condition, car accidents are likely to occur. To address such safety issues, a good number of technical solutions have been proposed. China Patent Application No. 200910310326.3, for example, discloses a driver monitoring apparatus and method which involves capturing images, detecting a driver's eye area and how the driver's hands are placed on the steering wheel, and thereby determining whether the driver's eyes are open or are closed because of tiredness and whether the driver's hands are placed on the correct positions on the steering wheel.

U.S. Pat. No. 8,045,766, entitled “Device, program, and method for determining sleepiness”, provides another kind of solution. More specifically, a driver's facial image is taken and then calculated by a specific algorithm. When the driver is found to be sleepy, an air supplying device and a seatbelt vibrator are activated to prevent the driver from sleeping. If necessary, a brake controller will be activated to provide further warning.

While the foregoing technical solutions for detecting a driver's condition and providing necessary warning are workable and are effective to some degree, they are incapable of rapidly and accurately detecting a driver's attention and mental condition.

### SUMMARY OF THE INVENTION

In view of the above, the present invention discloses an attention detection method based on a driver's reflex actions. Basically, a driver's mental condition and degree of attention are determined by detecting his or her instantaneous reflex actions. More specifically, a driver is expected to look to a light emitting unit that emits light. If the driver does not, it may indicate that the driver is tired or absentminded, and the driver's mental condition and degree of attention are thus determined. By detecting and determining the instantaneous reflex actions of the human eyes, the present invention features faster execution, more effectiveness, and higher accuracy than the conventional detection apparatuses.

The disclosed attention detection apparatus based on a driver's reflex actions essentially includes an image capturing unit, a processing unit, a safety determination unit, a safety testing unit, a sound generation unit, and a light emitting unit. The image capturing unit takes a head image and an eye image of the driver. The processing unit performs operations on the head image and the eye image. The safety testing unit issues a safety test instruction. The safety determination unit performs value comparison and determination on the eye image, detects variation of the eye image, and thereby determines whether the driver's actions meet the requirement of the safety test instruction. If the requirement is not met, the sound generation unit will send out an alarm signal to alert the driver. The light emitting unit emits light according to the safety test instruction.

The disclosed attention detection method based on a driver's reflex actions is carried out as follows. To begin with, a safety test instruction is issued, and a head image of the driver is obtained. The head image is subjected to digital image processing such that an eye searching area is generated. An eye image of the driver is then defined in the eye searching area. By detecting variation of the eye image, it is determined whether the eye image meets the requirement of the safety test instruction. If not, an alarm signal will be sent out to alert the driver.

### BRIEF DESCRIPTION OF THE SEVERAL VIEWS OF THE DRAWINGS

The objectives, technical contents, and features of the present invention will be best understood by referring to the following detailed description of a preferred embodiment in conjunction with the accompanying drawings, in which:

FIG. 1 is a structural diagram of the apparatus of the present invention;

FIG. 2 shows the first half of the flowchart of the method of the present invention;

FIG. 3 shows the second half of the flowchart of the method of the present invention;

FIG. 4 is a schematic drawing of the apparatus of the present invention;

FIG. 5 is a schematic drawing showing how an image is taken and processed according to the present invention;

FIG. 6 is another schematic drawing showing how an image is taken and processed according to the present invention;

FIG. 7 is yet another schematic drawing showing how an image is taken and processed according to the present invention;

FIG. 8 is a schematic drawing showing application of the present invention; and

FIG. 9 is another schematic drawing showing application of the present invention.

### DETAILED DESCRIPTION OF THE EMBODIMENTS OF THE INVENTION

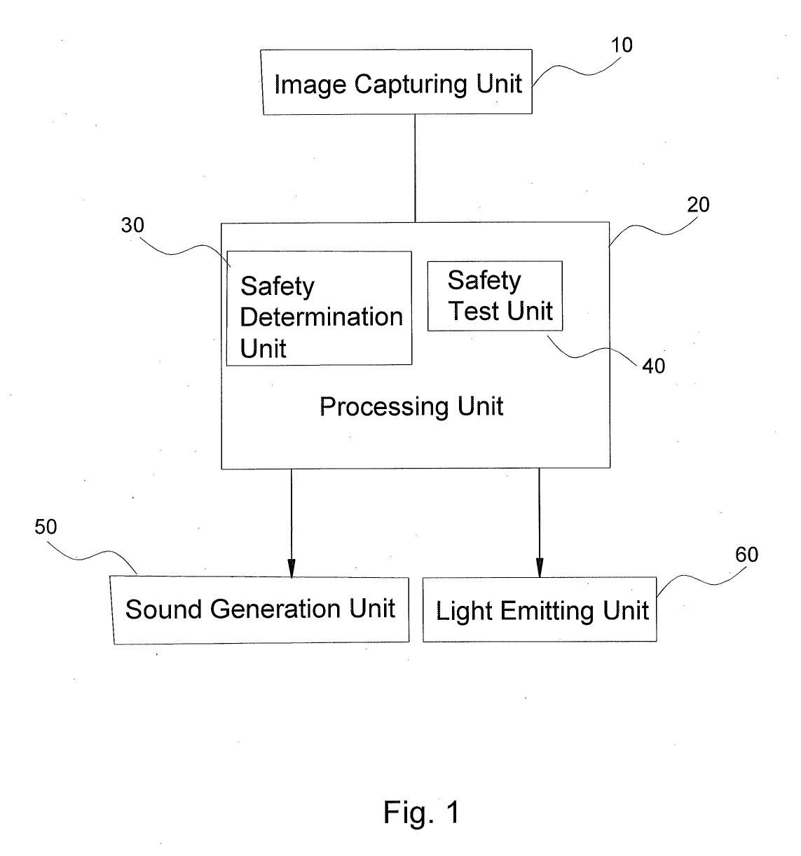

Please refer to FIG. 1 for a structural diagram of the apparatus of the present invention. The present invention provides an attention detection apparatus based on a driver's reflex actions, wherein the attention detection apparatus essentially includes an image capturing unit 10, a processing unit 20, a safety determination unit 30, a safety testing unit 40, a sound generation unit 50, and a light emitting unit 60. The image capturing unit 10 is connected to the processing unit 20 and is configured for capturing a head image and an eye image of a driver. The processing unit 20 performs operations on the head image, generates an eye searching area in the head image, and thus obtains the eye image of the driver for further processing and analysis. The safety determination unit 30 performs value comparison and determination on the eye image so as to obtain detection values and thereby monitor the driver's eye movements.

The safety testing unit 40 issues a safety test instruction and the light emitting unit 60 emits light according to the safety test instruction. The light emitting unit 60 may include two light emitting elements as appropriate, wherein the two light emitting elements can be arranged on the left side and the right side of the apparatus respectively. As soon as the light emitting unit 60 emits light, the driver is supposed to take notice and look to the light emitting unit 60. The safety determination unit 30 monitors variation of the eye image and determines whether the requirement of the safety test instruction is met. For example, when the left-side light emitting element of the light emitting unit 60 emits light, the driver should cast a rapid look on the left-side light emitting element such that the eye image is moved toward the left. If the driver's eyes do not move leftward to look at the light emitting element, it is determined that the driver is absentminded. Should that happen, the alarming device of the apparatus, such as the sound generation unit 50 or the light emitting unit 60, will send out an alarm signal.

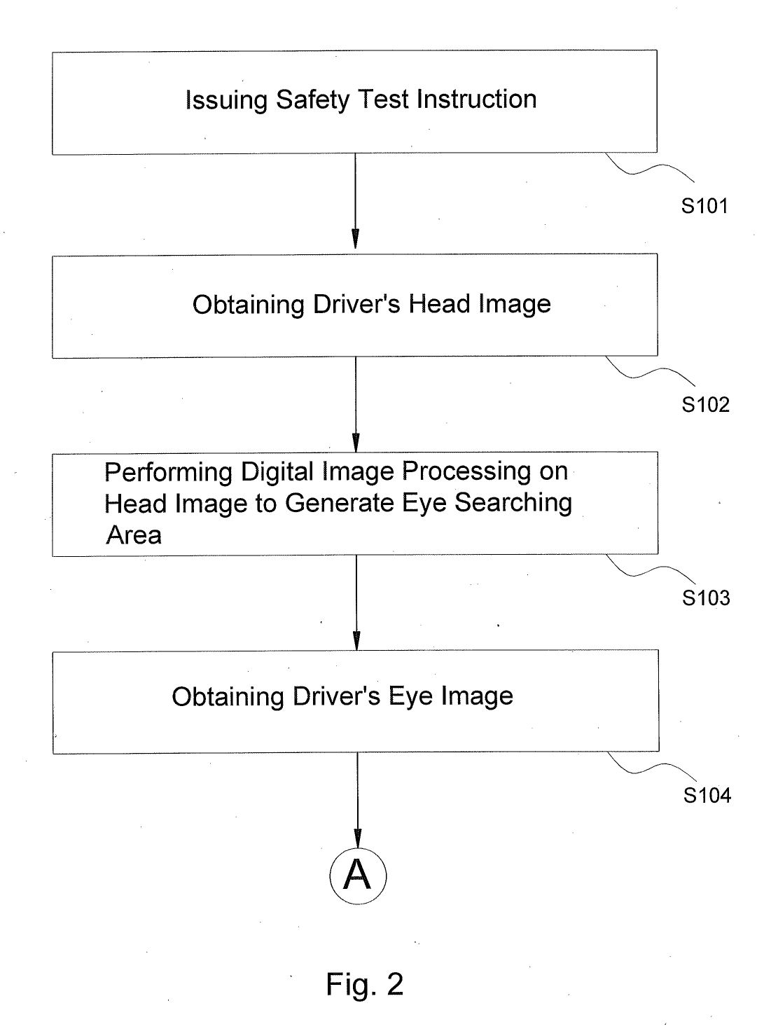

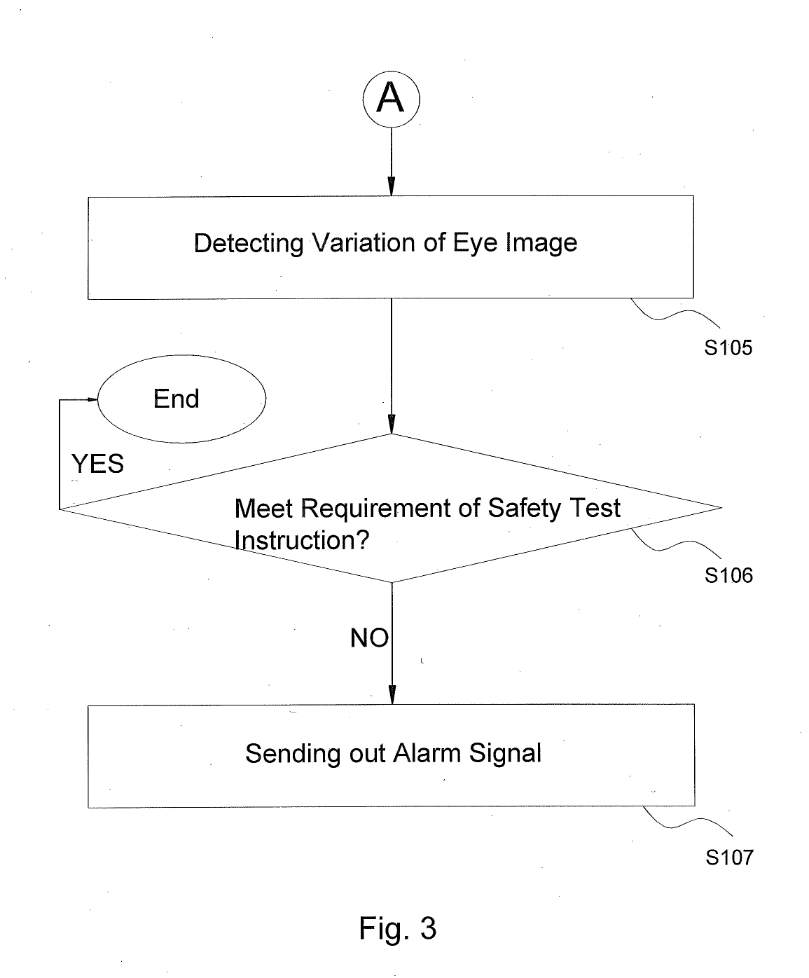

Please refer to FIG. 2 and FIG. 3 for a flowchart of the method of the present invention. The present invention provides an attention detection method based on a driver's reflex actions as detailed below. To start with, an apparatus issues a safety test instruction (S101). The safety test instruction can be so set that it is issued periodically or at random times. In addition, the safety test instruction can be so set that it causes a light emitting unit to emit light or a sound generation unit to generate sound. Following that, a head image of the driver is obtained via an image capturing unit such as a camera (S102). The head image is subjected to digital image processing to generate an eye searching area (S103), and an eye image of the driver is defined in the eye searching area (S104). The apparatus detects variation of the eye image (S105) and determines whether the variation of the eye image meets the requirement of the safety test instruction (S106). As stated above, the safety test instruction can be set differently. For instance, the safety test instruction can either cause the light emitting unit to emit a flicking light or cause the sound generation unit to make sound. If the driver looks to the light emitting unit that is flickering or the sound generation unit that is sounding, it is determined that the driver has a normal degree of attention, and the process is terminated. However, if the driver fails to look to the light emitting unit that is flicking or the sound generation unit that is sounding, an alarm signal will be sent out (S107) to alert the driver. It should be pointed out that the steps S102 to S104 are optional. As the eye image can be directly obtained by conventional techniques, it is not necessary to first take the head image and then obtain the eye image by analyzing the head image.

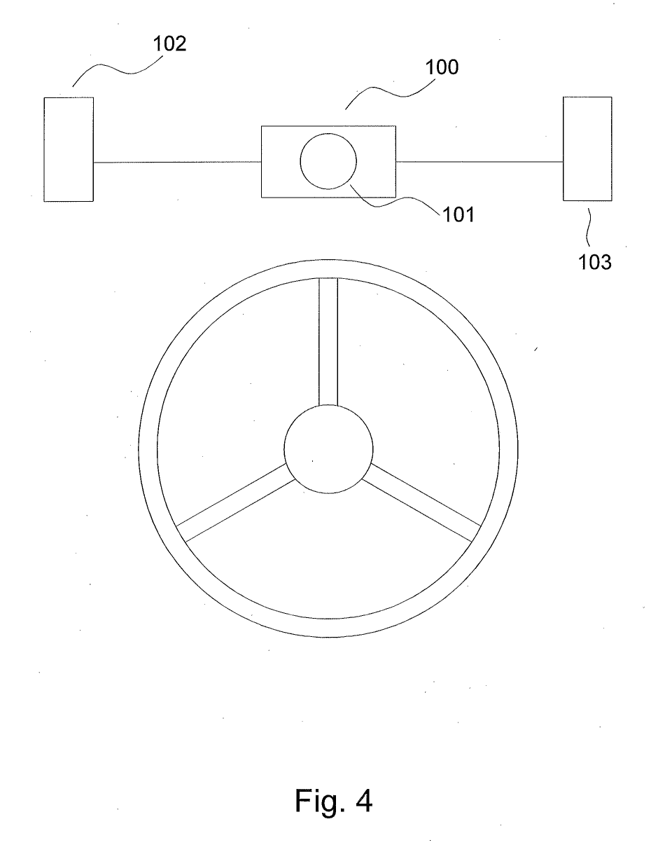

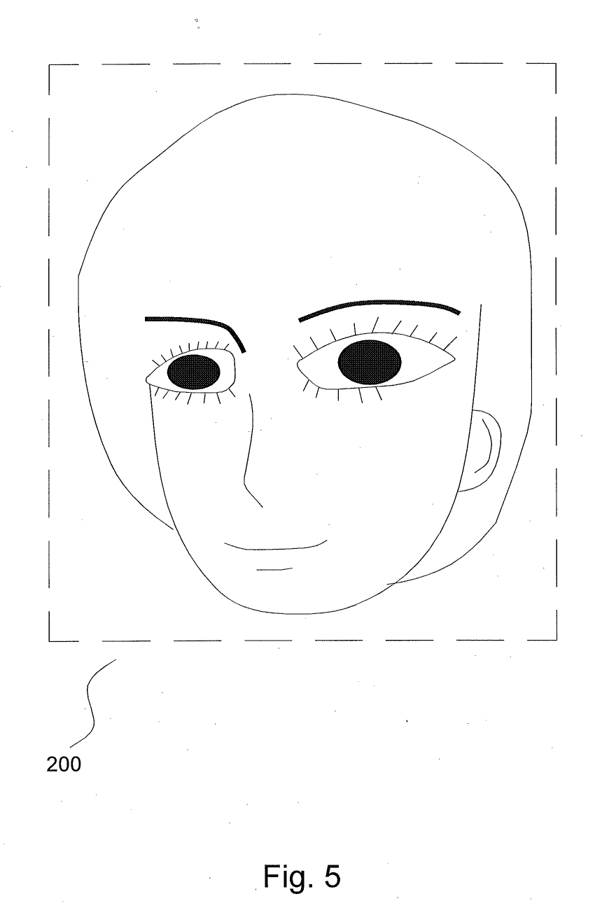

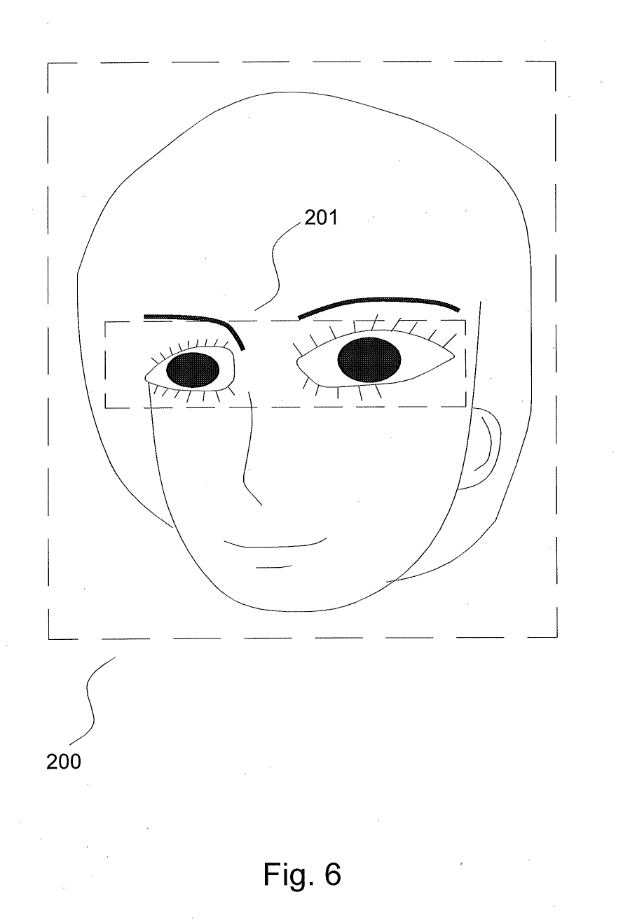

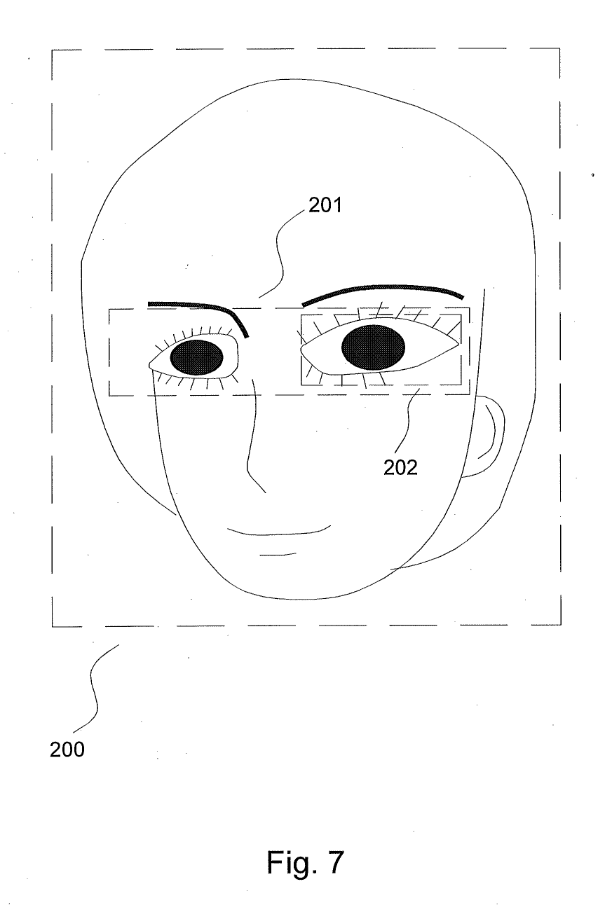

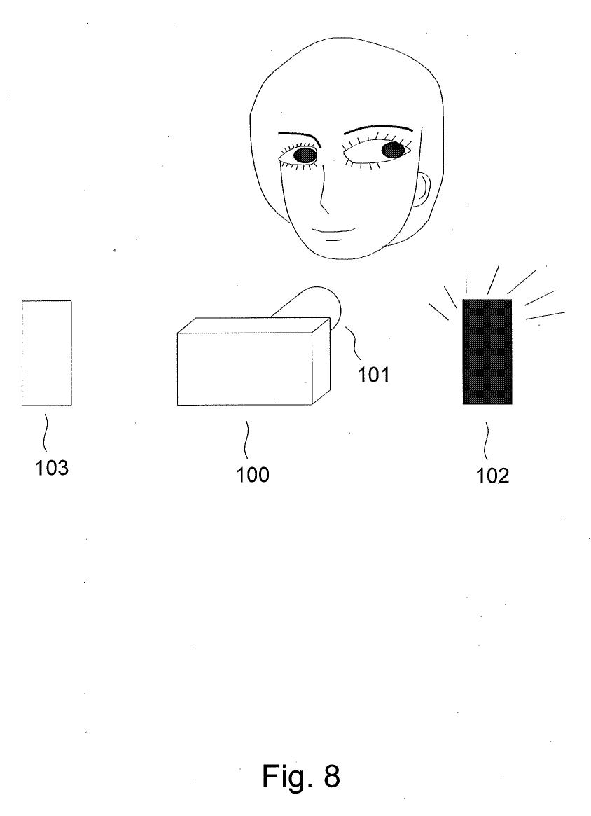

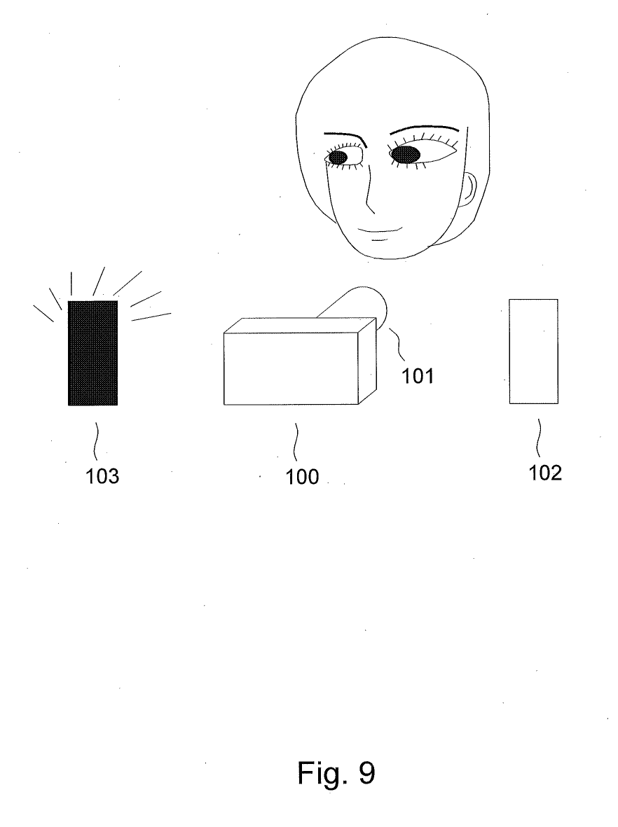

Application of the foregoing attention detection apparatus based on a driver's reflex actions is now described with reference to FIG. 4 to FIG. 9. The main body 100 of the apparatus of the present invention may be provided in front of the driver and adjacent to the dashboard of the vehicle. The camera 101 is configured for capturing a head image or an eye image of the driver. The first light emitting element 102 is provided on the left while the second light emitting element 103 is provided on the right. After the camera 101 captures a head image 200 of the driver, the processing unit 20 performs digital image processing on the head image 200 and thereby generates an eye searching area 201. Next, an eye image 202 is defined in the eye searching area 201 for further analysis and determination.

If the first light emitting element 102 flashes and the driver heads the flashing light by turning his or her eyes to the first light emitting element 102, the camera 101 will capture the variation of the eye image, which is changed from looking forward to looking leftward. Similarly, if the second light emitting element 103 flashes and the driver heads the flashing light by turning his or her eyes to the second light emitting element 103, the camera 101 will capture the variation of the eye image, which is changed from looking forward to looking rightward. If the driver's eyes do not turn to the first light emitting element 102 or the second light emitting element 103 that is flashing, the apparatus will generate an alarming sound to alert the driver.

The embodiment disclosed above is only the preferred embodiment and is not restrictive of the present invention. A person of ordinary skill in the art may make minor changes or modifications to the disclosed embodiment without departing from the spirit or scope of the present invention. The scope of the present invention is defined only by the appended claims.

What is claimed is:

1. An attention detection method based on a driver's reflex actions, comprising the steps of:
issuing a safety test instruction;
obtaining an image of the driver;
detecting variation of the image and determining whether the variation meets a requirement of the safety test instruction; and
sending out a warning signal if the variation of the image does not meet the requirement of the safety test instruction.

2. The attention detection method of claim 1, wherein the safety test instruction causes a light emitting unit to emit light.

3. The attention detection method of claim 2, wherein the step of detecting variation of the image and determining whether the variation meets a requirement of the safety test instruction comprises detecting whether the driver's eyes turn to the light emitting unit.

4. The attention detection method of claim 2, wherein the light emitting unit consists of two light emitting elements.

5. The attention detection method of claim 1, wherein the safety test instruction causes a sound generation unit to make sound.

6. The attention detection method of claim 5, wherein the step of detecting variation of the image and determining whether the variation meets a requirement of the safety test instruction comprises detecting whether the driver's eyes turn to the sound generation unit.

7. The attention detection method of claim 5, wherein the sound generation unit consists of two sound generation elements.

8. The attention detection method of claim 1, wherein the safety test instruction is issued periodically or at random times.

9. The attention detection method of claim 1, further comprising the steps of:
obtaining a head image of the driver;
performing digital image processing on the head image and defining an eye searching area in the head image; and
obtaining an eye image of the driver from the eye searching area.

10. The attention detection method of claim 1, wherein the alarm signal is a sound generated by a sound generation unit.
